(19) United States
(12) Patent Application Publication
(10) Pub. No.: US 2004/0004344 A1
(43) Pub. Date: Jan. 8, 2004

(54) Horn switch integrated with airbag module

(75) Inventors: Seo-hong Kim, Suwon-shi (KR); Jin-chul Hwnag, Suwon-shi (KR); Jung-bae Ahn, Youngin-shi (KR); Ju-hyung Seo, Suwon-shi (KR)

Correspondence Address: GREENBLUM & BERNSTEIN, P.L.C., 1950 ROLAND CLARKE PLACE, RESTON, VA, 20191, US

(73) Assignee: HYUNDAI MOBIS, Seoul (KR)

(21) Appl. No.: 10/318,047

(22) Filed: Dec. 13, 2002

(30) Foreign Application Priority Data
Jul. 5, 2002 (KR) 2002-38956

(51) Int. Cl. B60R 21/16

(52) U.S. Cl. 280/731

(57) ABSTRACT

A horn switch integrated with an airbag module, which is capable of utilizing the inside of a steering wheel more effectively by changing the mounting structure of a horn switch unit installed in the steering wheel, includes a fixed plate fixed in the steering wheel, a moving plate supported vertically movable by a plurality of coil springs mounted at an upper portion of the fixed plate and contacted with a lower portion of the airbag module, and a horn switch unit formed at an upper surface of the fixed plate and generating a horn when the moving plate is moved near or in contact with the fixed plate.

### BACKGROUND OF THE INVENTION

1. Field of the Invention

The present invention relates to a horn switch integrated with an airbag module, and more particularly to a horn switch integrated with an airbag module which is capable of utilizing the inner space of a steering wheel more effectively by changing a mounting structure of a horn switch unit installed in the steering wheel.

2. Description of the Related Art

Generally, a steering wheel is used to change the traveling direction of an automobile. By rotating the steering wheel right or left, an operating force transmitted through the steering shaft to a steering gear is exerted on wheels enabling steered cornering of the automobile.

Recently, an airbag module including an airbag has been installed inside the steering wheel in order to protect a driver in the case of a collision with the automobile. This airbag module is surrounded with an airbag cover for protection against external impacts.

In general, a ruptured point or weak portion is formed to the airbag cover so that the airbag can be inflated and then be fully expanded through the airbag, e.g. in case of a collision of the automobile.

On the other hand, there is needed a certain space in the airbag cover of the steering wheel in order to mount a horn switch. In most cases, the horn switch is installed in connection to the airbag and the central interior of the steering wheel.

FIGS. 1 and 2 are a plane view and a sectional view showing the mounting structure of a conventional horn switch, respectively.

As shown in the figures, the central inside of a steering wheel 1 mounted of a steering shaft 5 has a hollow shape, and an airbag module 3 including an airbag 2 is installed in the inner space.

Also, a compression spring 6 is interposed between a boss 1a and a lower portion of the airbag module 3 so as to continuously and elastically press the airbag module 3 upward against an airbag cover 4.

In addition, a bolt 9 is fixed to the boss 1a of the steering wheel 1, and the head of the bolt 9 catches the airbag module 3. Thus, the airbag module 3 pressed upward by the compression spring 6 is not completely taken off forward owing to the bolt 9.

Therefore, the airbag module 3 is installed to freely ascend and descend with the boss 1a of the steering wheel 1, while maintaining a certain gap with the inner frame of the steering wheel 1 due to the compression spring 6.

On the other hand, there are installed two contact parts 8 spaced apart a predetermined space between the boss 1a of the steering wheel 1 and a lower surface of the airbag module 3.

Therefore, if a driver pushes the airbag cover 4 surrounding the airbag module 3, the compression spring 6 is pressed downward by the airbag cover 4 and brings the two contact parts 8 into contact. Then, the two contact parts 8 are electrically connected to each other by their contact, and an alarm sound is generated for other drivers and outside passenger.

However, in the conventional art, since the horn switch is installed to the boss of the steering wheel, the installation space of the airbag module including the airbag is limited, hence the size of the airbag is also restricted to a limited range.

In addition, since the horn switch is installed to the boss of the steering wheel, there is a problem that assembling the horn switch in the steering wheel is complex and requires much time.

### SUMMARY OF THE INVENTION

The present invention is designed to solve the problem of the prior art, and an object of the present invention to provide a horn switch integrated with an airbag module which is capable of utilizing the inner space of a steering wheel more effectively by changing the mounting structure of a horn switch unit installed in the steering wheel.

In one aspect of the present invention, there is provided a horn switch integrated with an airbag module received in a steering wheel of an automobile, which comprises a fixed plate fixed to a boss of in the steering wheel; a moving plate supported vertically movable by a plurality of coil springs mounted at an upper portion of the fixed plate, the moving plate being in contact with a lower portion of the airbag module; and a horn switch unit for generating an alarm when the moving plate is moved near or comes in contact with the fixed plate.

Preferably, the fixed plate includes a stationary body fixed to the boss of the steering wheel; a plurality of spring fixing units protruding at four corners of the fixed body to prevent separation of the coil springs, each spring fixing unit having a groove at its upper center for combination; and guide protrusions at both sides of the fixed body for vertically guide movement of the moving plate.

In this case, it is also preferable that the moving plate includes a moving body provided at an upper portion of the fixed plate and having a predetermined thickness; holes perforated to the moving body with a predetermined diameter corresponding to the spring fixing units in order to combine the fixed plate and the moving plate with a predetermined space using bolts through the grooves; and guide parts vertically extended at both sides of the moving body, each guide part having a guide groove for guiding the guide protrusion.

The coil spring is preferably interposed between the hole of the moving plate and the spring fixing unit of the fixed plate.

A silencing material can also be inserted into the hole of the moving plate in order to prevent interference between an outer circumference of the bolt and the inner side of the hole.

Preferably, the horn switch unit includes at least one conductive film attached to a predetermined position on an upper surface of the fixed plate with a predetermined thickness; at least one contact part inserted to the moving plate in correspondence with the conductive film, the contact part being contacted with the conductive film when the moving plate descends; and at least one cable connected to the contact part and generating an electric signal when the conductive film is contacted with the contact part.

### BRIEF DESCRIPTION OF THE DRAWINGS

Other objects and aspects of the present invention will become apparent from the following description of embodiments with reference to the accompanying drawing in which:

FIG. 1 is a plane view showing a conventional steering wheel;

FIG. 2 is a sectional view showing an installation state of an airbag module and a horn switch according to the conventional art;

FIG. 3 is an exploded perspective view showing a horn switch according to the present invention; and

FIG. 4 is a sectional view showing the installation state of an airbag module and the horn switch according to the present invention.

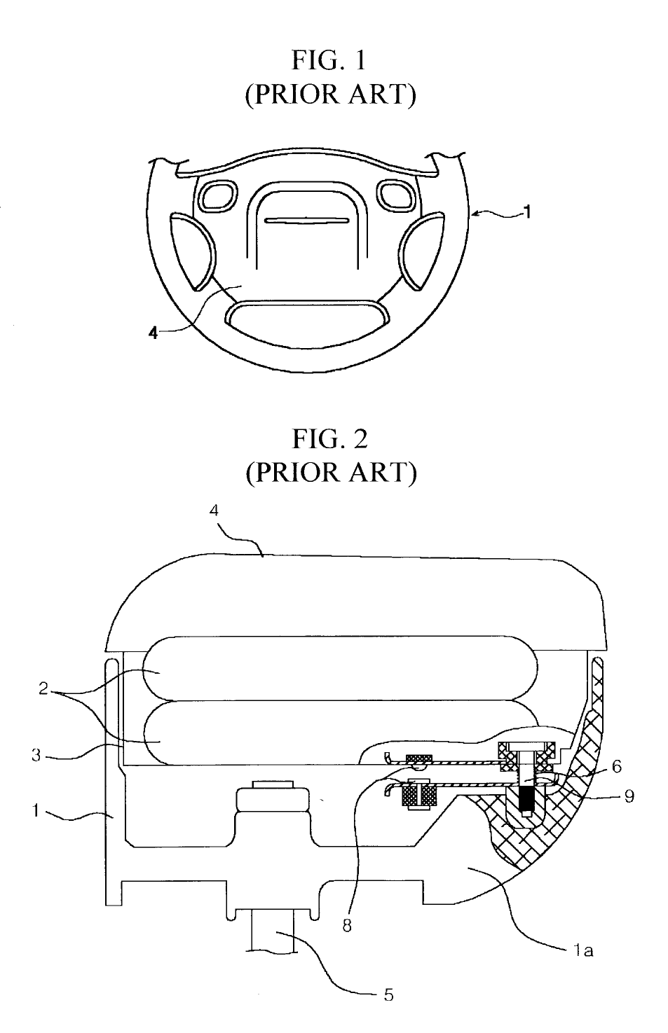

### DESCRIPTION OF THE PREFERRED EMBODIMENT

Hereinafter, a horn switch integrated with an airbag module according to the present invention will be described in more detail referring to the drawings.

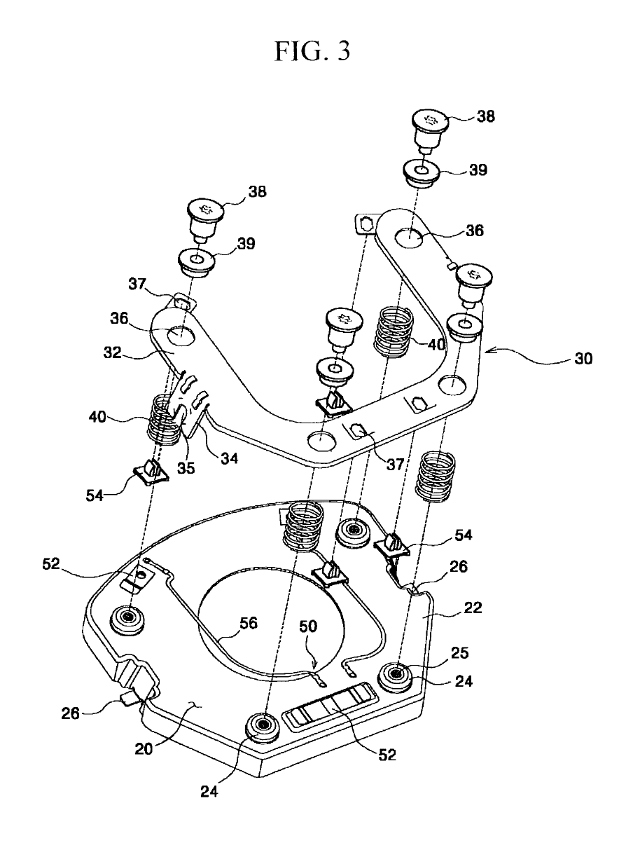

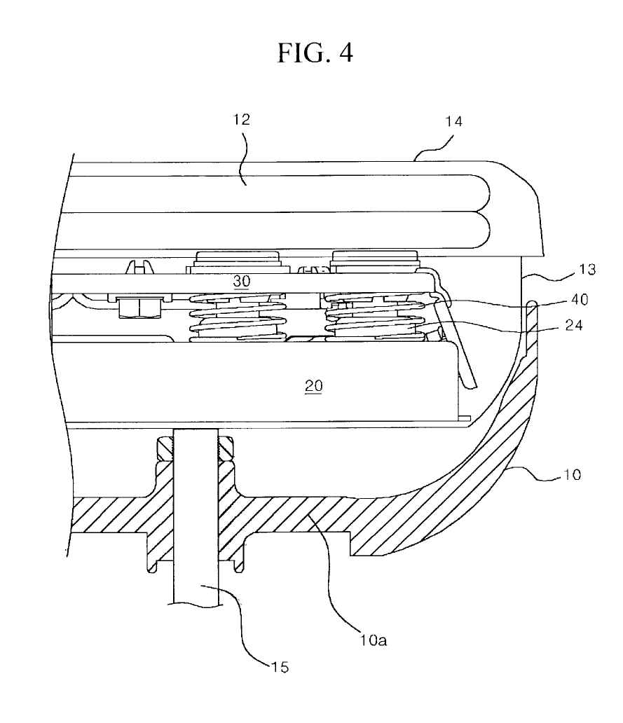

FIG. 3 is an exploded perspective view showing an horn switch according to the present invention, and FIG. 4 is a sectional view showing the installation state of an airbag module and the horn switch according to the present invention.

As shown in these figures, the horn switch integrated with the airbag module, installed in a steering wheel 10 of an automobile, includes a fixed plate 20 fixed to a boss 10a of the steering wheel 10 mounted to a steering shaft 15, a moving plate 30 supported vertically movable by a plurality of coil springs 40 with a predetermined space above the fixed plate 20 and contacted with the lower portion of the airbag module 13, and a horn switch unit 50 formed at an upper surface of the fixed plate 20 and generating an alarm when the moving plate 30 is moved near or in contact with the fixed plate 20.

As shown in FIG. 3, the fixed plate 20 having a predetermined shape is fixed or fit to the boss 10a of the steering wheel 10.

The moving plate 30 is in contact with the lower portion of the airbag module 13 including the airbag 12. The moving plate 30 may descend against the elastic force of the coil springs 40 interposed between the moving plate 30 and the fixed plate 20 when a pressing force is exerted to the airbag module 13. The descent of the moving plate 30 causes the generation of an alarm.

The fixed plate 20 includes a fixed body 22 fixed to the boss 10a of the steering wheel 10, a plurality of spring fixing units 24 protruding at four upper corners of the fixed body 22 to prevent separation of the coil springs 40 and having a groove 25 at the upper center for combination, and guide protrusions 26 protruding at both sides of the fixed body 22 to guide vertical movement of the moving plate 30.

The fixed body 22 is formed with a predetermined area and a predetermined thickness so as to be installed onto the boss 10a of the steering wheel 10.

In addition, a fixing part (not shown) can be formed at a lower edge of the fixed body 22 having a predetermined thickness so that this fixing part is interposed into the boss 10a of the steering wheel 10.

The fixed plate 22 may have a board shape, and a hole of a predetermined shape can be perforated at a center of the fixed plate 22.

In addition, the spring fixing unit 24 protrudes up to a predetermined height on an upper surface of the fixed body 22 in order to prevent separation of the above-mentioned coil spring 40.

A plurality of spring fixing units 24 can be formed onto the fixed body 22, and preferably four spring fixing units 24 are formed since there are four coil springs 40 provided as described below.

In addition, two spring fixing units 24 are formed at two corners of the one edge of the fixed body 22 (when seen from FIG. 3) and the other two spring fixing units 24 are formed at two corners of the other edge of the fixed body 22.

Also, the spring fixing unit 24 has a diameter similar to or same as that of the coil spring 40 used in the present invention so that the coil spring 40 can be fit thereto.

On an upper surface of the spring fixing unit 24, the groove 25 of a predetermined depth is formed for combination with a bolt 38.

On the other hand, the guide protrusions 26 are formed at opposite depressed side of the fixed body 22.

In addition, each of the guide protrusions 26 has a preferable width so as to be easily inserted into a guide groove 35, described later, and a distance not to be easily separated from the guide groove 35.

On the other hand, the moving plate 30 includes a moving body 32 provided at an upper portion of the fixed plate 20 with a predetermined thickness, holes 36 perforated to the moving body 32 with a predetermined diameter corresponding to the spring fixing units 24 in order to combine the fixed plate 20 and moving plate 30 with a predetermined space by using bolts 38 through the grooves 25, and guide parts 34 vertically extending at both sides of the moving body 32 and having a guide groove 35 for guiding the guide protrusion 26.

The moving body 32 formed at the upper portion of the fixed body 22 is in contact with or fixed to the airbag module 13. The moving body 32 has the shape of a thin board similar to a ‘ [symbol] ’ shape, and a size identical to that of the fixed body 22.

Also, the holes 36 are formed at positions on the moving body 32 corresponding to the four coil springs 40.

Of course, the holes 36 have a diameter smaller than that of the coil springs 40.

The hole 36 is arranged in a straight line with the coil spring 40 and the groove 25 of the spring fixing unit 24, and the bolt 38 is fastened thereto in order to combine the moving body 32 and the fixed body 22.

At this time, the bolts 38 are fastened while maintaining a predetermined space between the moving body 32 and the fixed body 22.

Also, the thread of the bolt 38 has a diameter smaller than that of the hole 36 so that the moving body 32 may easily ascend and descend, and a bolt head 38 has a diameter larger than that of the hole 36.

In addition, a lower portion of the airbag module 13 catches the head of the bolt 38.

On the other hand, the guide parts 34 protruded downward are formed at both sides of the moving body 32, and the guide groove 35 is formed at the center of the guide part 34 for guiding vertical movement of the moving body 32 by inserting the guide protrusion 26 thereto.

The guide groove 35 may have a closed edge, but preferably the guide groove 35 is open downward for combination with the guide protrusion 26.

At this time, a gap between the moving body 32 and the fixed body 22 combined by the bolts 38 is preferably adjusted so that the guide protrusions 26 may not be separated below the guide grooves 35.

Also, it is also preferred to provide a silencing material 39 providing a hollow center to the hole 36 in order to prevent noise when the moving body 32 descends by pressure toward the fixed body 22 and an outer circumference of the bolt 38 that collides with the hole 36 of the moving body 32.

The silencing material 39 is made of a durable rubber, capable of enduring friction of the bolt 38 well.

On the other hand, the coil springs 40 are formed at predetermined positions between the moving body 32 and the fixed body 22 to elastically support the moving body 32. Preferably, the coil springs 40 are interposed between the holes 36 of the moving body 32 and the spring fixing units 24 of the fixed body 22.

Also, the horn switch unit 50 includes at least one conductive film 52 attached to a predetermined position on the upper surface of the fixed plate 20 with a predetermined thickness, at least one contact part 54 inserted to the moving plate 30 in correspondence with the conductive film 52 and in contact with the conductive film 52 when the moving plate 30 descends, and at least one cable 56 connected to the contact part 54 and generating an electric signal when the conductive film 52 is in contact with the contact part 54.

There can be formed a plurality of conductive films 52 on the upper surface of the fixed body 22 of the fixed plate 20.

Though one conductive film 52 can be formed on the upper surface of the fixed body 22, a plurality of conductive films may ensure more stable electrical contact. In this embodiment, two conductive films 52 are preferably formed between the spring fixing units 24 at each edge portion of the upper surface of the fixed body 22.

Also, the conductive film 52 protrudes a predetermined length from the fixed body 22 in order to ensure stable contact with the contact part 54.

In addition, the conductive film 52 is made of a material which has excellent conductivity and does not generate noise when in contact with the contact part 54.

On the other hand, the contact part 54 is fit into the hole 37 formed at a position of the moving body 32 corresponding to the fixed body 22.

Also, the contact part 54 can be also attached to the lower surface of the moving plate 32.

The contact part 54 is made of a material which does not generate noise when in contact with the conductive film 52.

In addition, the cable 56 is connected to the contact part 54 in order to electrically connect the conductive film 52 and the contact part 54 and generate a signal when the conductive film 52 and the contact part 54 touch each other.

Hereinafter, operation of the present invention constructed as above is described in detail.

The fixed body 22 of the fixed plate 20 is installed into the steering wheel 10 and the fixed body 22 is supported on the boss 10a of the steering wheel 10.

In addition, owing to the elastic force of the coil spring 40 interposed between the fixed plate 20 and the moving plate 30, the moving body 32 of the moving plate 30 is in contact with the lower portion of the airbag module 13.

In this state, when pressing the airbag cover 14 protecting the airbag module 13, the airbag 12 of the airbag module 13 pushes the moving body 32, so the coil springs 40 are compressed.

As the coil springs 40 are compressed, the contact part 54 formed onto the lower surface of the moving body 32 comes in contact with the conductive film 52 formed on the upper surface of the fixed body 22. If the contact part 54 is in contact with the conductive film 52, an electrical signal is generated through the cable 56 connected to the contact part 54, hence an alarm is generated.

If releasing the pressure exerted on the airbag cover 14, the contact part 54 of the moving body 32 is separated from the conductive film 52 of the fixed body 22 due to the elastic force of the coil spring 40, and the horn is stopped.

According to the horn switch integrated with the airbag module of the present invention constructed as above, since the horn switch unit is formed below the airbag module, the number of parts is decreased, hence the inner space of the steering wheel can be utilized more efficiently.

In addition, since the horn switch unit is installed below the airbag module, which is located outside, and not inside the steering wheel, the horn switch can be manufactured and assembled more easily.

What is claimed is:

1. A horn switch integrated with an airbag module received in a steering wheel of an automobile, comprising:
a fixed plate fixed to a boss of the steering wheel;
a moving plate supported vertically movable by a plurality of coil springs mounted at an upper portion of the fixed plate, the moving plate being in contact with a lower portion of the airbag module; and
a horn switch unit for generating an alarm when the moving plate is moved near or contacted with the fixed plate.

2. A horn switch integrated with an airbag module according to claim 1, wherein the fixed plate includes:
a fixed body fixed to the boss of the steering wheel;
a plurality of spring fixing units protruding at four corners of the fixed body to prevent separation of the coil springs, each spring fixing unit having a groove at an upper center for combination; and
guide protrusions respectively protruding at both sides of the fixed body to guide vertical movement of the moving plate.

3. A horn switch integrated with an airbag module according to claim 2, wherein the moving plate includes:
a moving body provided at an upper portion of the fixed plate and having a predetermined thickness;
holes perforated to the moving body with a predetermined diameter corresponding to the spring fixing units in order to combine the fixed plate and the moving plate with a predetermined space by using bolts through the grooves; and
guide parts vertically extended at both sides of the moving body, each guide part having a guide groove for guiding the guide protrusion.

4. A horn switch integrated with an airbag module according to claim 3, wherein the coil spring is interposed between the hole of the moving plate and the spring fixing unit of the fixed plate.

5. A horn switch integrated with an airbag module according to claim 3, wherein a silencing material is inserted into the hole of the moving plate in order to prevent interference between the outer circumference of the bolt and the inside of the hole.

6. A horn switch integrated with an airbag module according to claim 1, wherein the horn switch unit includes:
at least one conductive film attached to a predetermined position on an upper surface of the fixed plate with a predetermined thickness;
at least one contact part inserted to the moving plate in correspondence with the conductive film, the contact part in contact with the conductive film when the moving plate descends; and
at least one cable connected to the contact part and generating an electric signal when the conductive film is in contact with the contact part.
